(19) United States
(12) Patent Application Publication
(10) Pub. No.: US 2024/0427107 A1
(43) Pub. Date: Dec. 26, 2024

(54) MANUAL LASHER APPARATUS

(71) Applicant: SSW Splicing Inc., Wellston, OK (US)

(72) Inventor: Stephen Scott Webb, Wellston, OK (US)

(21) Appl. No.: 18/748,851

(22) Filed: Jun. 20, 2024

Related U.S. Application Data
(60) Provisional application No. 63/509,635, filed on Jun. 22, 2023.

(51) Int. Cl. G02B 6/48; B65H 49/20; B65H 57/14

(52) U.S. Cl. CPC G02B 6/483; B65H 49/205; B65H 57/14; B65H 2701/362

(57) ABSTRACT

An apparatus for lashing a cable with a lashing wire includes a housing for containing a spool of lashing wire, a handle extending from the housing, a wire guide assembly, and a wire tensioning member. The wire guide assembly is supported above a top side of the housing adjacent to a wire outlet so that when the lashing wire is threaded through the wire guide assembly, the lashing wire is redirected toward a front end of the housing. The wire tensioning member is supported adjacent to the front end of the housing so that the lashing wire extending from the wire guide assembly can be threaded around the wire tensioning member and wrapped around the cable and a support strand.

### CROSS-REFERENCE TO RELATED APPLICATIONS

This application claims the benefit of U.S. Provisional Application No. 63/509,635, filed Jun. 22, 2023, which is hereby incorporated herein by reference in its entirety.

### BACKGROUND

Telecommunication cables, such as fiber optic cables, are frequently routed by connecting the cables to overhead support wiring, or support strands, suspended from a series of utility poles. The cable is commonly tied or “lashed” to a support strand tightly strung between the poles to prevent the cables from sagging between adjacent poles. For this purpose, a cable lashing machine is often pulled along the support strand to lash the cable to the strand. Before a lasher is used, the cable is loosely supported by temporary support brackets hung from the support strand. The lasher is mounted on the support strand to engage the loosely supported cable. One or more spools of lashing wire are loaded onto the lasher, and a free end is clamped to the strand or otherwise secured at a starting point. The lasher is then pulled along the support strand. The loosely suspended cable slips through the front end of the lasher as the lasher moves along the strand. As the lasher is pulled along the strand, the lashing wire is helically wrapped around the cable and the strand to bind the cable to the strand.

One of the drawbacks of many conventional lashers is that they are relatively heavy, particularly when only minor repairs are required of a cable network. In use, an individual must carry the lasher, sometimes up a ladder, and position it on the support strand and the cable. The lashing machine is used to lash the cable to the support strand, and then the lashing machine must be removed and brought back to the ground. Because of its weight, workers are susceptible to injury when using conventional lasher machines.

Another problem with conventional lashers is the inability to maintain uniform tension on the lashing wire during use. If consistent tension is not maintained, a uniformly tight wind cannot be achieved.

To this end, a need exists for an improved manual cable lasher that is easy to use and that operates to affect a uniformly tight wind of lashing wire while preventing any slackening caused by the inadvertent backward rotation of the lasher during use. It is to such an improved manual cable lasher that the inventive concepts disclosed herein are directed.

### BRIEF DESCRIPTION OF THE DRAWINGS

FIG. 1 is a perspective view of a manual lasher apparatus constructed in accordance with the inventive concepts disclosed herein shown housing a spool of lashing wire.

FIG. 2 is a perspective view of the lasher apparatus of FIG. 1 shown in an open position.

FIG. 3 is a front perspective view of the lasher apparatus of FIG. 1.

FIG. 4 is a partially cutaway, top-plan view of the lasher apparatus of FIG. 1.

FIG. 5A is a cross-sectional view of the lasher apparatus taken along line 5-5 of FIG. 1.

FIG. 5B is a cross-sectional view of another embodiment of a lasher apparatus constructed in accordance with the inventive concepts disclosed herein.

FIG. 6 is a cross-sectional view of the lasher apparatus of FIG. 5A with the spool of lashing wire removed.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or being practiced or carried out in various ways. Also, it is to be understood that the phraseology and terminology employed herein are for the purpose of description and should not be regarded as limiting the inventive concepts disclosed and claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” and any variations thereof are intended to cover a non-exclusive inclusion. For example, a process, method, article, or apparatus that comprises a list of elements is not necessarily limited to only those elements. It may include other elements not expressly listed or inherently present therein.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments disclosed herein. This is done merely for convenience and to give a general sense of the inventive concepts. This description should be read to include one or at least one, and the singular also includes the plural unless it is obvious that it is meant otherwise.

As used herein, qualifiers like “substantially,” “about,” “approximately,” and combinations and variations thereof are intended to include not only the exact amount or value they qualify but also some slight deviations therefrom, which may be due to manufacturing tolerances, measurement error, wear and tear, stresses exerted on various parts, and combinations thereof, for example.

Finally, as used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

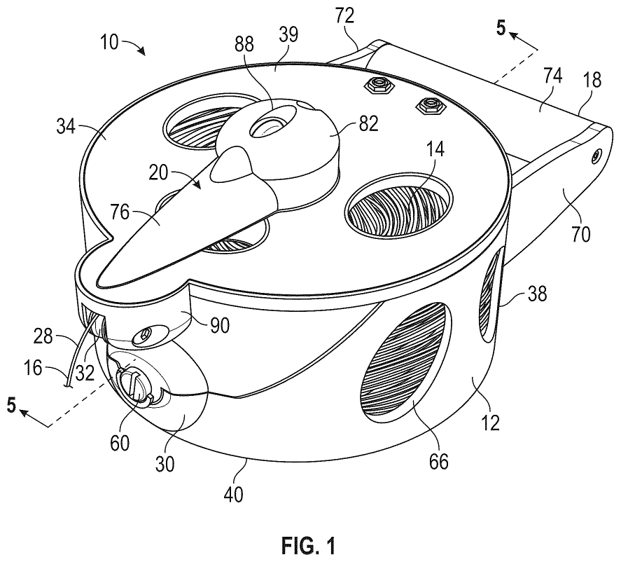

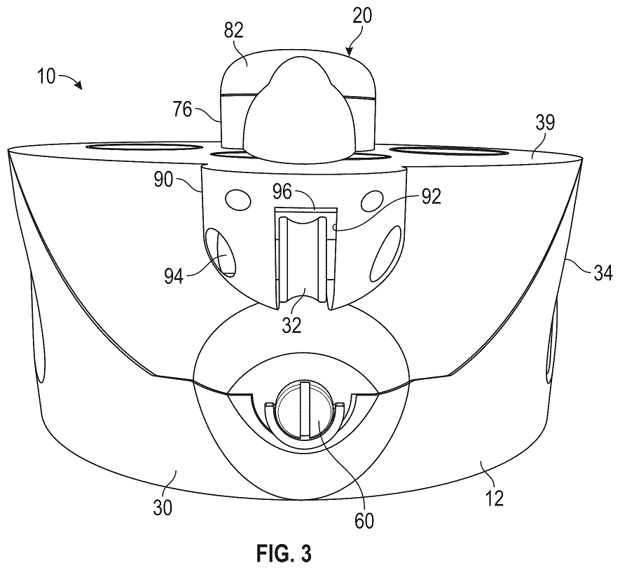

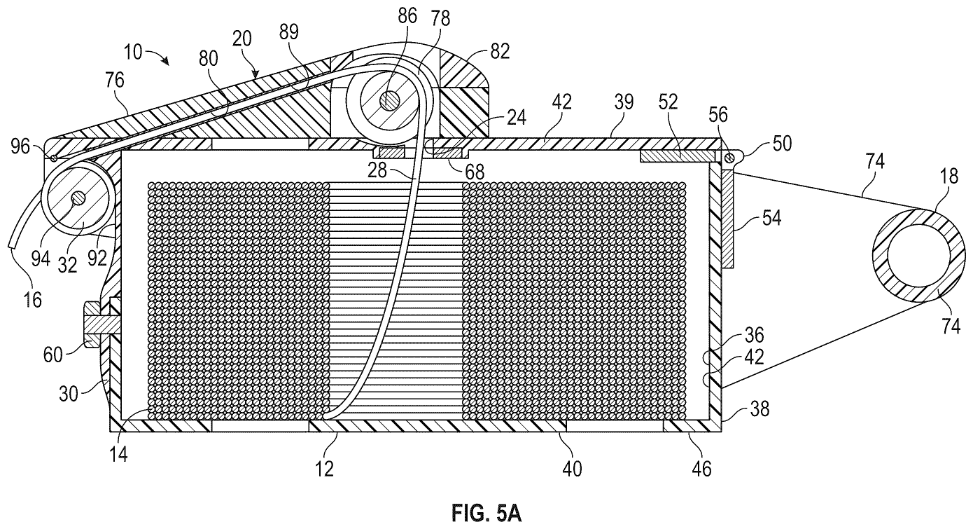

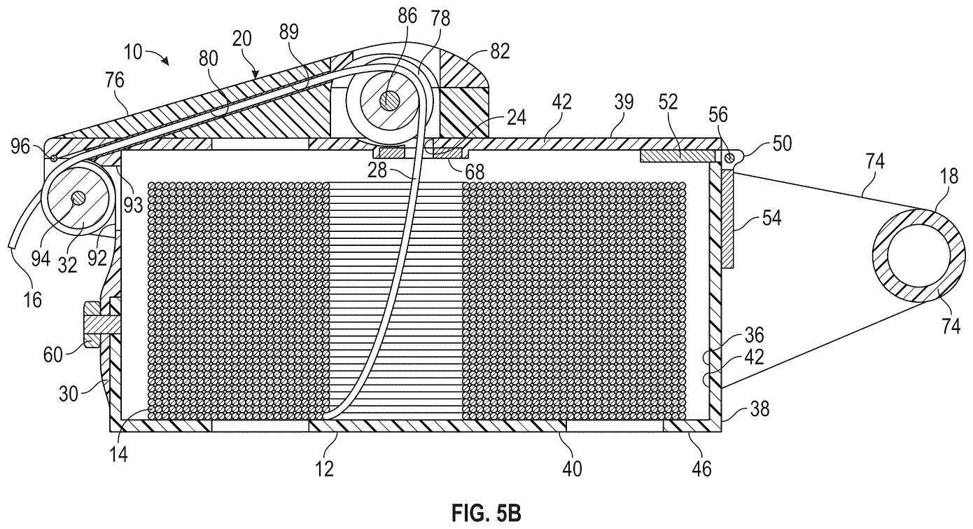

Referring now to the drawings, and more particularly to FIGS. 1-6, a manual lasher apparatus 10 constructed in accordance with the inventive concepts disclosed herein is illustrated. The lasher apparatus 10 includes a housing 12 for containing a spool of lashing wire 14 (FIGS. 1 and 5), a handle 18 extending from the housing 12, a wire guide assembly 20, and a wire tensioning member 32. As illustrated in FIG. 5A, the spool of lashing wire 14 includes a lashing wire 28 that has a terminal end 16 originating from an internal side 26 of the spool of lashing wire 14.

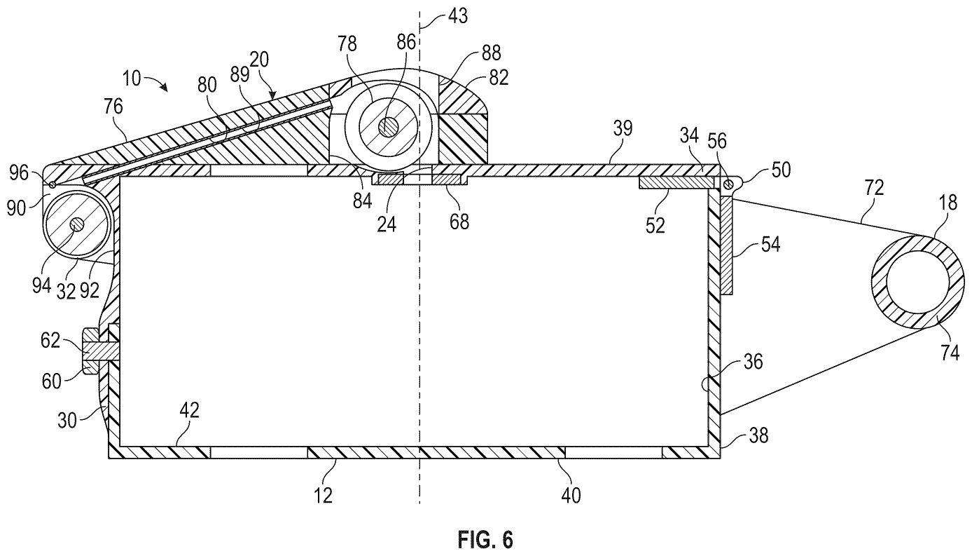

In one embodiment, the housing 12 has an exterior side 34, an interior side 36, a front end 30, a rear end 38, a top side 39, and a bottom side 40. The housing 12 defines a spool receiving chamber 42 for receiving the spool of lashing wire 14, and a central axis 43 (FIG. 6) extends from the top side 39 to the bottom side 40, about which the spool of lashing wire 14 (FIGS. 1 and 5) is positioned. A wire outlet 24 extends through the top side 39 of the housing 12 in substantial alignment with the central axis 43 (FIG. 6) so the terminal end 16 of the lashing wire 28 can be threaded through the wire outlet 24 from the internal side 26 of the spool of lashing wire 14 when the spool of lashing wire 14 is positioned in the spool receiving chamber 42.

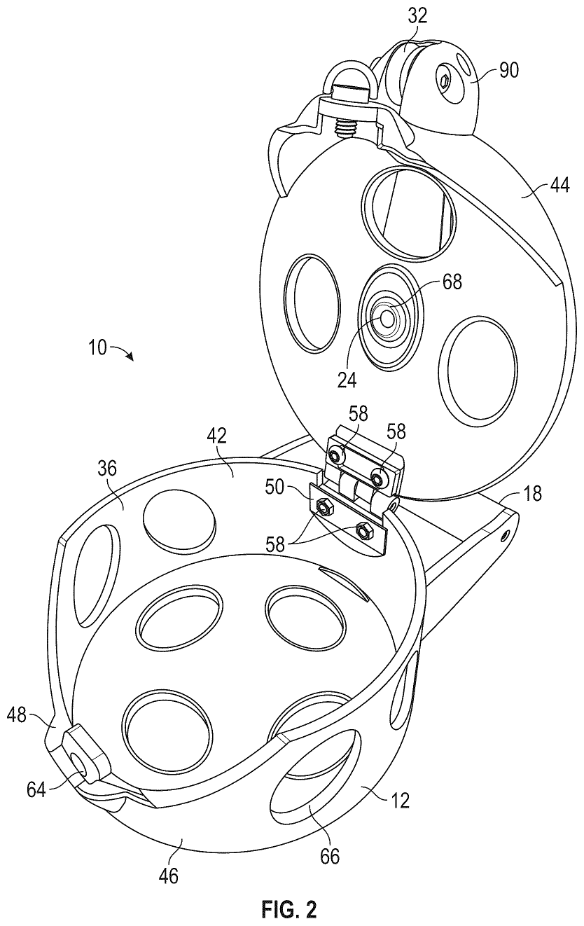

The housing 12 may include a first portion 44 and a second portion 46. Together, the first portion 44 and the second portion 46 may have a generally circular, cylindrical shape. The first portion 44 may be connected to the second portion 46, so the first portion 44 and the second portion 46 are movable relative to one another between an open position (FIG. 2) wherein the spool of lashing wire 14 may be inserted into or removed from the spool receiving chamber 42, and a closed position (FIG. 1) wherein the first portion 44 and the second portion 46 are positioned about the spool of lashing wire 14 when the spool of lashing wire 14 is positioned in the spool receiving chamber 42.

The first portion 44 and the second portion 46 of the housing 12 may be configured to facilitate the insertion and removal of the spool of lashing wire 14 into and from the spool receiving chamber 42. For example, the second portion 46 of the housing 12 may be configured to have a generally open front end 48 (best shown in FIG. 2) so the spool of lashing wire 14 may be grasped when positioning the spool of lashing wire 14 into the spool receiving chamber 42 and when removing the spool of lashing wire 14 therefrom. The first portion 44 of the housing 12 may be configured to close the generally open front end 48 of the second portion 46 when the first portion 44 and the second portion 46 are in the closed position.

In one embodiment, the first portion 44 and the second portion 46 may be connected with a hinge 50. The hinge 50 may include a first plate 52 connected to the first portion 44, a second plate 54 connected to the second portion 46, and a pin 56 rotatably connecting the first plate 52 to the second plate 54. The first plate 52 and the second plate 54 may be connected to the first portion 44 and the second portion 46 of the housing 12, respectively, with a plurality of suitable fasteners, such as fasteners 58 (FIG. 2).

The first portion 44 and the second portion 46 of the housing 12 may be secured in the closed position with a suitable latch assembly, such as a latch assembly 60. In one embodiment, the latch assembly 60 may include a threaded member 62 secured to the first portion 44 that threadedly engages a threaded aperture 64 (FIG. 2) formed in the second portion 46.

As best shown in FIG. 2, the spool receiving chamber 42 of the housing 12 has a circular, cylindrical shape, which substantially conforms to the contour of the spool of lashing wire 14. It will be appreciated, however, that the spool receiving chamber 42 may be formed in various shapes.

In one embodiment, the first portion 44 and the second portion 46 of the housing 12 may be constructed of a durable, lightweight polymeric material, such as polylactic acid, acrylonitrile butadiene styrene, polyethylene terephthalate glycol, thermoplastic elastomers, or polycarbonate. To further decrease the weight of the housing 12, the first portion 44 and the second portion 46 of the housing 12 may be formed to have a plurality of voids 66. The wire outlet 24 may be reinforced with an eyelet 68 made of a wear-resistant material, such as stainless steel.

Referring now to FIGS. 1 and 4-6, the handle 18 extends from the rear end 38 of the housing 12. The handle 18 may include a first extension member 70, a second extension member 72, and a crossbar 74 extending between the first extension member 70 and the second extension member 72, so the handle 18 may be manually gripped and used to exert a pulling force on the housing 12. The handle 18 is illustrated as being oriented horizontally, but the handle 18 can be oriented in other directions, such as vertically.

Referring to FIGS. 1 and 4-6, in one non-limiting embodiment, the wire guide assembly 20 includes a base member 76, a wire guide member 78, a tubular wire guide 80 (FIGS. 5 and 6), and a cover 82. The base member 76 is configured to be connected to the exterior side 34 of the housing 12 with suitable fasteners or adhesive. The base member 76 includes a wire guide member receiving compartment 84 with an open lower end in communication with the wire outlet 24 so the terminal end 16 of the lashing wire 28 may pass from the housing 12 to the wire guide member receiving compartment 84.

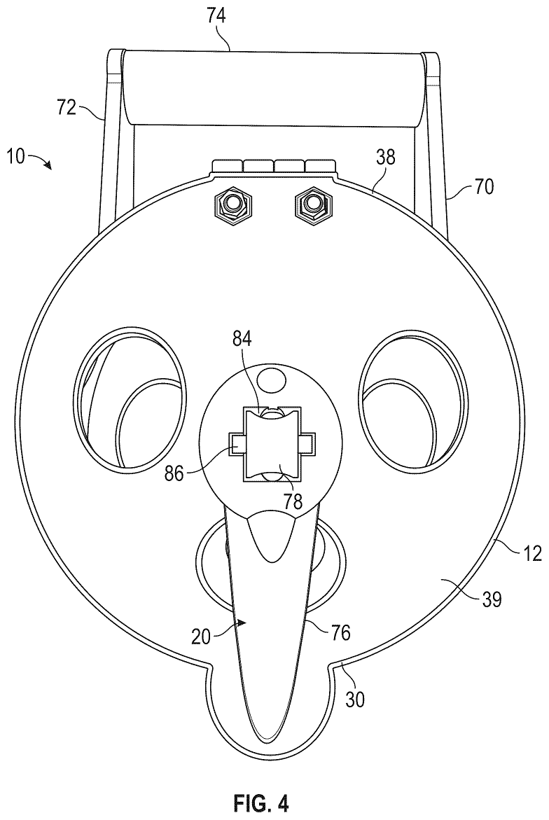

The wire guide member 78 is supported in the wire guide member receiving compartment 84. The wire guide member 78 serves to redirect the lashing wire 28 toward the front end 30 of the housing 12. In one embodiment, the wire guide member 78 is a roller. The roller may be rotatably supported within the wire guide member receiving compartment 84 by an axle 86 (FIGS. 4-6). The roller may be constructed of durable material, such as stainless steel. In another embodiment, the wire guide member 78 can be a fixed curved surface along which the lashing wire 28 can slide.

In one embodiment, the cover 82 may be connected to the base member 76 over the wire guide member receiving compartment 84 to provide a vertical constraint on the wire guide member 78 as well as protect the lashing wire 28 as it passes over the wire guide member 78 and into the tubular wire guide 80 during use. The cover 82 may have an opening 88 to facilitate threading of the lashing wire 28 over the wire guide member 78 and into the tubular wire guide 80.

The base member 76 has a bore 89 extending from a position adjacent to the wire guide member 78 and angling downward toward the lower side of the base member 76, so the bore 89 is substantially tangentially aligned with an upper portion of the wire guide member 78. The bore 89 can serve as the tubular wire guide 80 positioned between the wire guide member 78 and the wire tensioning member 32, so the lashing wire 28 extending between the wire guide member 78 and the wire tensioning member 32 is enclosed. However, in another embodiment, the bore 89 is lined with a tubular wire guide 80 constructed of a durable material, such as stainless steel.

With reference to FIGS. 1-3, 5A, and 6, the wire tensioning member 32 is connected to the exterior side 34 of the housing 12 adjacent to the front end 30 of the housing 12 in a way that the lashing wire 28 extending from the wire guide assembly 20 can be threaded around the wire tensioning member 32. In one embodiment, the wire tensioning member 32 is supported by a protrusion 90 of the housing 12 adjacent to the top side 39 of the housing 12. The protrusion 90 includes a portion of the tubular wire guide 80 and a slot 92 for receiving the wire tensioning member 32. The tubular wire guide 80 intersects the slot 92, so the lashing wire 28 passing from the tubular wire guide 80 can be positioned about the wire tensioning member 32.

The wire tensioning member 32 is supported in the slot 92 of the protrusion 90. The wire tensioning member 32 serves to maintain tension on the lashing wire 28 extending from the wire tensioning member 32 beyond the lasher apparatus 10, so when a pulling force is exerted on the lasher apparatus 10 during use, the lashing wire 28 remains taught between the lasher apparatus 10 and the portion of the lashing wire 28 that has been fixed or lashed. In one embodiment, the wire tensioning member 32 is a roller. The roller may be rotatably supported within the slot 92 by an axle 94. The roller may be constructed of durable material, such as stainless steel. In another embodiment, the wire tensioning member 32 can be a fixed circular surface along which the lashing wire 28 can slide. In yet another embodiment, the wire tensioning member 32 may include two or more wire tensioning members.

The wire tensioning member 32 is sized so that the lashing wire 28 extending from the tubular wire guide 80 may be wrapped around the wire tensioning member 32, as illustrated in FIG. 5A. To facilitate wrapping the terminal end 16 of the lashing wire 28 around the wire tensioning member 32, the protrusion 90 may have a curved surface substantially conforming to the contour of the wire tensioning member 32.

In another embodiment illustrated in FIG. 5B, the protrusion 90 may include an opening 93, providing access between the slot 92 and the spool receiving chamber 42. The opening allows the terminal end 16 of the lashing wire 28 to be threaded through the opening 93 into the spool receiving chamber 42, rethreaded back through the opening 93, and finally threaded around the wire tensioning member 32.

An anti-wear member 96 may be fixed to the top of the slot 92 in substantial alignment with the front-most edge of the slot 92 to prevent the lashing wire 28 from damaging the protrusion 90 when the lasher apparatus 10 is in use.

In use, the spool of lashing wire 14 is inserted into the housing 12, and the terminal end 16 of the lashing wire 28 is fed through the wire outlet 24, through the wire guide assembly 20, and around the wire tensioning member 32. The housing 12 is opened by disengaging the latch assembly 60 and separating the first portion 44 and the second portion 46. Once the housing 12 is open, and the spool receiving chamber 42 is exposed, the spool of lashing wire 14 is placed in the spool receiving chamber 42 so the center of the spool of lashing wire 14 is substantially aligned with the central axis 43 of the housing 12.

Before closing the housing 12, the terminal end 16 of the lashing wire 28 is threaded through the wire outlet 24, the base member 76, and the cover 82, so that the terminal end 16 of the lashing wire 28 extends beyond the opening 88 of the cover 82. The housing 12 may then be closed, and the latch assembly 60 engaged, ensuring sufficient lashing wire 28 remains extended between the cover 82 and the terminal end 16 of the lashing wire 28 to thread the lashing wire 28 through the remainder of the wire guide assembly 20 and around the wire tensioning member 32. The lashing wire 28 may then be threaded over the wire guide member 78, through the tubular wire guide 80, and around the wire tensioning member 32. With sufficient lashing wire 28 extended beyond the lasher apparatus 10, between the wire tensioning member 32 and the terminal end 16 of the lashing wire 28, the terminal end 16 of the lashing wire 28 may be fixed to a cable or support strand in a manner well known with a cable connector commonly known as a “bug nut.”

Alternatively, the housing 12 may remain open. The lashing wire 28 may then be threaded over the wire guide member 78, through the tubular wire guide 80, and around the wire tensioning member 32 by threading the lashing wire 28 through the opening 93 (FIG. 5B) into the spool receiving chamber 42, rethreading the lashing wire 28 back through the opening 93 and finally threading lashing wire 28 around the wire tensioning member 32.

With sufficient lashing wire 28 extended beyond the lasher apparatus 10, between the wire tensioning member 32 and the terminal end 16 of the lashing wire 28, the terminal end 16 of the lashing wire 28 may be fixed to a cable or support strand in a manner well known with a cable connector commonly known as a “bug nut.”

With the terminal end 16 of the lashing wire 28 extending beyond the lasher apparatus 10 and fixed to the cable or support strand, the lasher apparatus 10 is ready for use. The lasher apparatus 10 is pulled away from the fixed point to remove the lashing wire 28 from the internal side 26 of the spool of lashing wire 14 without the spool of lashing wire 14 rotating relative to the housing 12. Maintaining the tension on the lashing wire 28 between the lasher apparatus 10 and the portion of the lashing wire 28 that has been fixed, the lasher apparatus 10 is then manually rotated around both the cable and support strand so that the lashing wire 28 is helically wrapped around the same, resulting in the cable being tightly lashed to the support strand.

When the lashing wire 28, extending from the wire tensioning member 32 beyond the lasher apparatus 10, has been substantially used to lash the cable to the support strand, then the lasher apparatus 10 is again pulled away from the last lashed or fixed point so the lashing process may be continued. The pulling force exerted on the lasher apparatus 10 varies between the pulling force required to remove the lashing wire 28 from the lasher apparatus 10 and the pulling force needed to maintain the tension of the lashing wire 28 between the lasher apparatus 10 and the portion of the lashing wire 28 that has been fixed or lashed. Until the desired end point along the support strand is reached, where the lashing wire 28 is cut and fixed to an endpoint, the pulling force should substantially remain at or above the pulling force required to maintain the tension of the lashing wire 28. This will ensure the cable is tightly lashed to the support strand, minimizing the sagging the cable may experience.

Although the presently disclosed inventive concepts have been described in conjunction with the specific language set forth herein, many alternatives, modifications, and variations will be apparent to those skilled in the art. Accordingly, it is intended to embrace all such alternatives, modifications, and variations that fall within the spirit and broad scope of the presently disclosed inventive concepts. Changes may be made in the construction and the operation of the various components, elements, and assemblies described herein, without departing from the spirit and scope of the presently disclosed inventive concepts.

What is claimed is:

1. An apparatus for lashing a cable with a lashing wire originating from a spool of lashing wire, the lashing wire having a terminal end originating from an interior side of the spool of lashing wire, comprising:
a housing having an exterior side, an interior side, a front end, a rear end, a top side, a bottom side, a spool receiving chamber, a central axis extending from the top side to the bottom side about which the spool of lashing wire is positionable, and a wire outlet extending through the top side in substantial alignment with the central axis so the terminal end of the spool of lashing wire can be threaded through the wire outlet when the spool of lashing wire is positioned in the spool receiving chamber;
a handle extending from the rear end of the housing;
a wire guide assembly supported above the top side of the housing adjacent to the wire outlet in a way that when the lashing wire is threaded through the wire guide assembly, the lashing wire is redirected toward the front end of the housing; and
a wire tensioning member supported adjacent to the front end of the housing in a way that the lashing wire extending from the wire guide assembly can be threaded around the wire tensioning member and wrapped around a cable and a support strand.

2. The apparatus of claim 1, wherein the wire guide assembly comprises:
a guide member supported above the top side of the housing adjacent to the wire outlet so that when the lashing wire is threaded through the wire guide assembly, the lashing wire is redirected toward the front end of the housing.

3. The apparatus of claim 2, wherein the wire guide member is circular.

4. The apparatus of claim 3, wherein the wire guide member is a roller.

5. The apparatus of claim 2, wherein the wire guide assembly further comprises:
a tubular wire guide positioned between the wire guide member and the wire tensioning member so the lashing wire extending between the wire guide member and the wire tensioning member is enclosed.

6. The apparatus of claim 5, wherein the wire guide assembly further comprises:
a base member connected to the exterior side of the housing on the top side thereof, the base member supporting the wire guide member and the tubular wire guide.

7. The apparatus of claim 6, wherein the wire guide assembly further comprises:
a cover connected to the base member to secure the wire guide member to the base member.

8. The apparatus of claim 1, wherein the wire tensioning member is circular.

9. The apparatus of claim 8, wherein the wire tensioning member is a roller.

10. The apparatus of claim 1, wherein the housing has a protrusion extending from the exterior side at the front end thereof, the protrusion having a slot in which the wire tensioning member is positioned, the protrusion having a curved surface adjacent to a portion of the wire tensioning member.

11. The apparatus of claim 1, wherein the housing includes a first portion and a second portion, the first portion being connected to the second portion so the first portion and the second portion of movable relative to one another between an open position wherein the spool of lashing wire may be inserted into or removed from the spool receiving chamber and a closed position wherein the first portion and the second portion are positioned about the spool of lashing wire when the spool of lashing wire is positioned in the spool receiving chamber.

12. The apparatus of claim 1, wherein the spool receiving chamber has a circular, cylindrical shape.

13. An apparatus in combination with a lashing wire originating from a spool of lashing wire, the lashing wire having a terminal end originating from an interior side of the spool of lashing wire, the apparatus comprising:
a housing having an exterior side, an interior side, a front end, a rear end, a top side, a bottom side, a spool receiving chamber in which the spool of lashing wire is positioned, a central axis extending from the top side to the bottom side about which the spool of lashing wire is positioned, and a wire outlet extending through the top side in substantial alignment with the central axis, the terminal end of the spool of lashing wire threaded through the wire outlet;
a handle extending from the rear end of the housing;
a wire guide member connected to the exterior side of the housing adjacent to the wire outlet, the lashing wire being threaded over the wire guide member so the lashing wire is redirected toward the front end of the housing; and
a wire tensioning member connected to the exterior side of the housing adjacent to the front end of the housing,
wherein the lashing wire extending from the wire guide member threaded around the wire tensioning member.

14. The combination of claim 13, further comprising:
a tubular wire guide positioned between the wire guide member and the wire tensioning member so the lashing wire extending between the wire guide member and the wire tensioning member is enclosed.

15. The combination of claim 13, wherein the wire guide member is circular.

16. The combination of claim 15, wherein the wire guide member is a roller.

17. The combination of claim 13, wherein the wire tensioning member is circular.

18. The combination of claim 17, wherein the wire tensioning member is a roller.

19. The combination of claim 13, wherein the housing has a protrusion extending from the exterior side at the front end thereof, the protrusion having a slot in which the wire tensioning member is positioned, the protrusion having a curved surface adjacent to a portion of the wire tensioning member.

20. The combination of claim 13, wherein the housing includes a first portion and a second portion, the first portion being connected to the second portion, so the first portion and the second portion of movable relative to one another between an open position wherein the spool of lashing wire may be inserted into or removed from the spool receiving chamber and a closed position wherein the first portion and the second portion are positioned about the spool of lashing wire.
